(19) United States
(12) Patent Application Publication
(10) Pub. No.: US 2022/0380218 A1
(43) Pub. Date: Dec. 1, 2022

(54) GRAPHENE SYNTHESIS UNIT

(71) Applicant: NABORS ENERGY TRANSITION SOLUTIONS LLC, Houston, TX (US)

(72) Inventors: Evan JOHNSON, Spring, TX (US); Dylan Cook, Spring, TX (US); Paul Yollin, Tomball, TX (US); Aaron Adler, Olympia, WA (US)

(21) Appl. No.: 17/664,074

(22) Filed: May 19, 2022

Related U.S. Application Data
(60) Provisional application No. 63/191,242, filed on May 20, 2021.
(60) Provisional application No. 63/219,545, filed on Jul. 8, 2021.

(51) Int. Cl. C01B 32/184

(52) U.S. Cl. CPC C01B 32/184; C01P 2002/54

(57) ABSTRACT

A system for graphene synthesis includes an enclosed chamber having a hollow interior, a carbon-based gas source fluidically coupled to the chamber and configured to supply a carbon-based gas to the hollow interior, a hydrogen source fluidically coupled to the chamber and configured to supply hydrogen to the hollow interior, an oxygen source that is independent of the carbon-based gas source and that is fluidically coupled to the chamber and configured to supply oxygen to the hollow interior, an igniter configured to ignite the carbon-based gas, hydrogen, and oxygen in the hollow interior, a first flow meter coupled to the carbon-based gas source, a second flow meter coupled to the hydrogen source, a third flow meter coupled to the oxygen source, and a controller in communication with and configured to receive flow data from the first, second, and third flow meters.

### CROSS-REFERENCE TO RELATED APPLICATION(S)

This Application claims priority under 35 U.S.C. § 119(e) to U.S. Provisional Patent Application No. 63/191,242, entitled “SYSTEMS AND METHODS FOR A CARBON CAPTURE UNIT,” by Evan Johnson et al., filed May 20, 2021, and claims priority under 35 U.S.C. § 119(e) to U.S. Provisional Patent Application No. 63/219,545, entitled “SYSTEMS AND METHODS FOR A CARBON CAPTURE UNIT,” by Evan Johnson et al., filed Jul. 8, 2021, both of which are assigned to the current assignee hereof and incorporated herein by reference in their entireties.

### FIELD OF THE DISCLOSURE

The present disclosure relates to a unit for the synthesis and collection of graphene. More particularly, the present disclosure relates to a method, system, and apparatus for conversion of flue gases, flare gases, and hydrocarbon gases into useful carbon nanomaterial.

### BACKGROUND

It is well understood at this time that carbon, particularly complexed in CO and CO₂, but in any form that can convert into a greenhouse gas, is causing worldwide temperature increases. Various technologies are being developed to capture carbon resulting from human activities, primarily industrial processes, fossil fuel and other combustion from vehicles (e.g., airplanes, cars & trucks, and commercial and residential uses).

Graphene is a hexagonal lattice made of at least a single layer and up to 10 layers of sp2 (hexagonal) bonded of carbon atoms. Graphene has many desirable properties, such as high conductivity of heat and electricity along its plane, unique optical properties, and high mechanical strength. Due to these properties, graphene has a variety of applications including energy storage, electronics, semiconductors, composites, and membranes.

Existing combustion-based technologies for producing graphene use an oxygen-and-carbon-based gas mixture. However, these techniques do not fully and consistently break down carbon, thereby yielding an inconsistent product.

### BRIEF DESCRIPTION OF THE DRAWINGS

Various embodiments of the present disclosure will be understood more fully from the detailed description given below and from the accompanying drawings of various embodiments of the disclosure. In the drawings, like reference numbers may indicate identical or functionally similar elements. Embodiments are described in detail hereinafter with reference to the accompanying figures, in which:

FIG. 1 is a schematic diagram of a carbon capture system according to an embodiment of the present disclosure;

FIG. 2 is a flow chart of a method according to an embodiment of the present disclosure.

### DETAILED DESCRIPTION

The following disclosure provides many different embodiments or examples. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

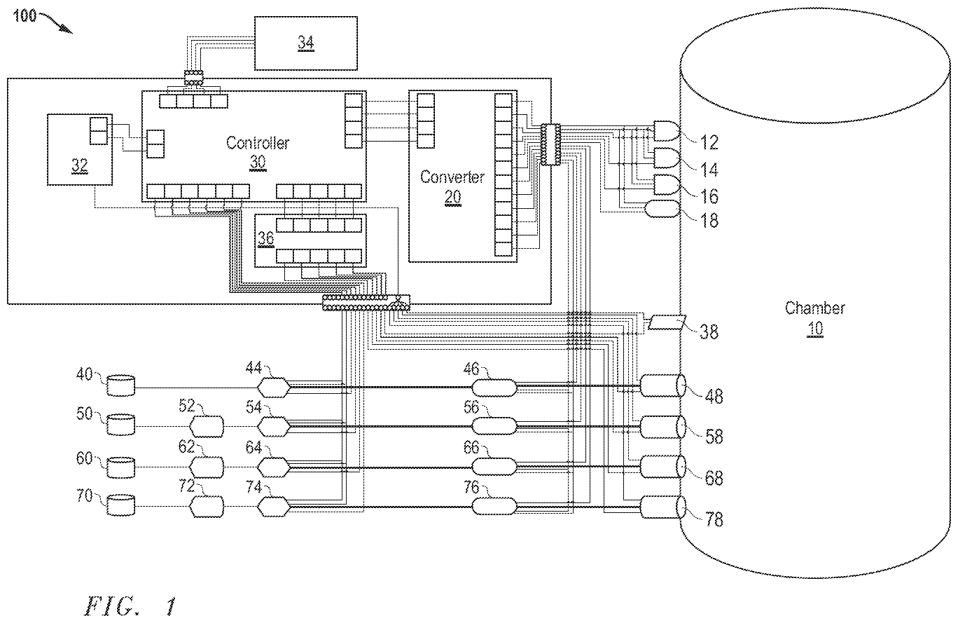

With reference to FIG. 1, a carbon capture system 100 according to embodiments of the present disclosure includes a reaction chamber 10 for conversion of hydrocarbon gas or liquid into graphene. The system 100 may be scaled as needed and may be located onsite, for example, at a hydrocarbon drilling operation or other suitable hydrocarbon feedstock site. Advantageously, the apparatus and methods disclosed herein permit a wide range of hydrocarbons to be used as a feedstock thereby converting numerous types of carbon-containing fluids, such as industrial flue gas output or flare gas output, to generate a valuable product, e.g., graphene. Thus, the disclosure herein beneficially teaches to capture a variety of carbon in industrial outputs and minimize greenhouse gas emissions therefrom while providing a valuable product for further industrial processes, materials, and equipment, for example, graphene-coated proton electron membranes. The reaction chamber 10 of FIG. 1 may be a heavy-duty chamber with multiple injection ports for controlled injection of the hydrocarbon material and separate injection of oxygen and hydrogen that forces re-bonding of carbon, hydrogen, and oxygen when ignited to form graphene and other products that do not contribute to greenhouse gas emissions, such as water. Without being bound by theory, the use of controlled, separate injection of oxygen and hydrogen allows for a much faster combustion of the hydrocarbon material as compared with traditional oxidizing agents; this permits a more complete breakdown of the hydrocarbon material. The reaction chamber 10 may be formed of any suitable material, such as aluminum, titanium aluminum, nickel aluminum, cast iron, steel, and the like. In some embodiments, the reaction chamber 10 is configured to withstand combustion pressures, such as at least about 1000 psi of internal pressure. In other embodiments, the reaction chamber 10 is configured to withstand at least about 5,000 psi, about 10,000 psi or even 15,000 psi of internal pressure.

The reaction chamber 10 may include one or more sensors configured to monitor and measure conditions within the reaction chamber 10. In some embodiments, the reaction chamber 10 includes a temperature sensor 18 configured to measure a temperature within the reaction chamber 10. In some embodiments, the reaction chamber 10 includes a low pressure sensor 16, a pressure sensor 14, and a high pressure sensor 12, each configured to measure a pressure within the reaction chamber 10. In one or more embodiments, the reaction chamber 10 may include an opacity sensor configured to measure an opacity within the reaction chamber 10. In some embodiments, the reaction chamber 10 may include a vacuum valve configured to create a vacuum within the reaction chamber 10 as a precursor to introducing any reactants (or inert gas). In some embodiments, the reaction chamber 10 includes a pressure release valve configured to release pressure from the reaction chamber 10. The pressure release valve may be actuated once a threshold pressure is reached within the reaction chamber 10 and/or on demand, for example, at a set time after each combustion within the reaction chamber 10.

The system includes an inert gas source 40, a flue gas or flare gas source 50, an oxygen source 60, and a hydrogen source 70 each in fluidic communication with the reaction chamber 10. The inert gas source 40 is arranged to provide a supply of an inert gas, such as argon, under pressure to the reaction chamber 10, wherein said pressure may be monitored by a pressure sensor 44. The inert gas provides an inert environment for clean combustion within the reaction chamber 10. For instance, the inert environment may prevent or suppress formation of NOₓ (nitrogen oxides) that might otherwise occur. A flow meter 46 is provides between the inert gas source 40 and the reaction chamber 10 and the flow meter 46 is configured to measure a flow rate of inert gas from the inert gas source 40 into the reaction chamber 10. The inert gas is introduced into the reaction chamber 10 through an injection port 48, which may include a one-way valve in order to maintain pressure within the reaction chamber 10 and avoid flashback. In some embodiments, the one-way valve is a solenoid valve.

The flue gas or flare gas source 50 supplies a carbon-based gas or liquid to the reaction chamber 10. Suitable carbon-based gases or liquids include a variety of commercial and industrial output products that include carbon, typically in a hydrocarbon, which include but are not limited to carbon dioxide, methane, propane, acetylene, butane, or combinations thereof. According to still other embodiments, the carbon-based gases or liquids may include aromatic compounds, such as benzene, toluene, methylnaphthalene, pyrolyzed fuel oils, coal tar, coal, heavy oils, oils, biooils, biodiesels, other bioderived hydrocarbons, or combinations thereof. Further, unsaturated hydrocarbon compounds, such as ethylene, acetylene, butadiene, and styrene can also be used. Still further, oxygen-containing hydrocarbons such as ethanol, methanol, propanol, phenols, ketones, ethers, esters, and similar compounds can be used. The carbon content of the carbon-based gases or liquids is not particularly limited. In some embodiments, the flue gas or flare gas source 50 is an exhaust stream from an industrial reaction process, such as a coal energy plant, a drilling operation, a combustion engine, or a landfill. In other embodiments, the exhaust stream from said industrial reaction process may be collected and stored in a tank or other vessel that may be used later in the system 100. In some embodiments, the flue gas or flare gas source 50 comprises a holding tank configured to receive and pressurize the exhaust stream from such an industrial process to provide a consistent feedstock pressure to the apparatus herein. In any embodiment, the flue gas or flare gas source 50 may include a pressure sensor 54 in communication therewith configured to monitor a pressure of the carbon-based gas or liquid from the flue gas or flare gas source 50. Between the flue gas or flare gas source 50 and the reaction chamber 10 is a flow meter 56 configured to measure a flow rate of the carbon-based gas or liquid from the flue gas or flare gas source 50 into the reaction chamber 10. The carbon-based gas or liquid is introduced into the reaction chamber 10 through an injection port 58, which may include a one-way valve in order to maintain pressure within the reaction chamber 10 and avoid flashback. In some embodiments, the one-way valve is a solenoid valve. In some embodiments, a flash arrester 52 may also be included between the flue gas or flare gas source 50 and the reaction chamber 10, e.g., between the pressure sensor 54 and the flue gas or flare gas source 50. The flash arrester 52 may include a sensor configured to detect flashback during the combustion process in the reaction chamber 10 and, in response, shut down the system 100 to minimize or avoid the risk of explosion or fire.

The oxygen source 60 supplies oxygen gas to the reaction chamber 10. In some embodiments, the oxygen source 60 is pressurized at about 50 psi or greater. In some embodiments, the oxygen source 60 receives oxygen from a proton exchange membrane (PEM) electrolyzer and, optionally, pressurizes the oxygen. In other embodiments, the oxygen source 60 comprises an oxygen cylinder. In any embodiment, the oxygen source 60 may include a pressure sensor 64 in communication therewith configured to monitor a pressure of the oxygen from the oxygen source 60. Between the oxygen source 60 and the reaction chamber 10 is a flow meter 66 configured to measure a flow rate of the oxygen from the oxygen source 60 into the reaction chamber 10. The oxygen is introduced into the reaction chamber 10 through an injection port 68, which may include a one-way valve in order to maintain pressure within the reaction chamber 10 and avoid flashback. In some embodiments, the one-way valve is a solenoid valve. In some embodiments, a flash arrester 62 may also be included between the oxygen source 60 and the reaction chamber 10, e.g., between the pressure sensor 64 and the oxygen source 60. The flash arrester 62 may include a sensor configured to detect flashback during the combustion process in the reaction chamber 10 and, in response, shut down the system 100.

The hydrogen source 70 supplies hydrogen gas to the reaction chamber 10. In some embodiments, the hydrogen source 70 is pressurized at about 50 psi or greater. In some embodiments, the hydrogen source 70 receives hydrogen from a proton exchange membrane (PEM) electrolyzer and, optionally, pressurizes the hydrogen. In other embodiments, the hydrogen source 70 comprises a hydrogen cylinder. In any embodiment, the hydrogen source 70 may include a pressure sensor 74 in communication therewith configured to monitor a pressure of the hydrogen from the hydrogen source 70. Between the hydrogen source 70 and the reaction chamber 10 is a flow meter 76 configured to measure a flow rate of the hydrogen from the hydrogen source 70 into the reaction chamber 10. The hydrogen is introduced into the reaction chamber 10 through an injection port 78, which may include a one-way valve in order to maintain pressure within the reaction chamber 10 and avoid flashback. In some embodiments, the one-way valve is a solenoid valve. In some embodiments, a flash arrester 72 may also be included between the hydrogen source 70 and the reaction chamber 10, e.g., between the pressure sensor 74 and the hydrogen source 70. The flash arrester 72 may include a sensor configured to detect flashback during the combustion process in the reaction chamber 10 and, in response, shut down the system 100.

The reaction chamber 10 includes a reaction initiation reaction initiation device 38 used to supply a required energy to initiate a reaction, such as a spark plug. The reaction initiation device 38 is configured to initiate a series of precisely timed combustions. For example, each combustion event may last about a millisecond. The spacing between combustions and the duration of combustions may be appropriately adjusted based on the measured conditions of the system 100. In one or more embodiments, the reaction initiation device 38 is positioned at a mid-point of the reaction chamber 10. According to this configuration, as particles of the reactants (flue gas or flare gas, oxygen, and hydrogen) accelerate in each direction the particles hit at each end and assemble the graphene.

The system 100 also includes a controller 30 configured to receive inputs from the sensors within the system 100 and to control combustion conditions within the reaction chamber 10. In some embodiments, the controller 30 in configured to receive inputs from one or more of the flow meters 46, 56, 66, 76, the temperature sensor 18, the low pressure sensor 16, the pressure sensor 14, the high pressure sensor 12, and the pressure sensors 44, 54, 64, 74. In some embodiments, the controller 30 comprises a converter 20 configured to receive said inputs as analog signals and convert the analog signals into digital signals.

The controller 30 may also include a driver 36. In some embodiments, the driver 36 is configured to actuate one or more of the solenoid valves at injection ports 48, 58, 68, 78 and/or to actuate the reaction initiation device 38. In some embodiments, the controller 30 may also include a power distributor 32 to distribute power throughout the system, for example, to the solenoid valves at injection ports 48, 58, 68, 78 and to the reaction initiation device 38.

In one or more embodiments, the system 100 includes a user interface 34. The user interface 34 may display any one or more of the measurements from the sensors described above. In some embodiments, the user interface 34 may be configured to allow customization of the combustion conditions, such as flow rates, pressure, and temperature. The user interface 34 may allow for individual control of each parameter of the system 100 and/or may include pre-programmed functions.

In one or more embodiments, the reaction chamber 10 is maintained at about 100° F. or less before combustion, which helps build pressure once graphene is produced. Without being bound by theory, it is believed that the temperature during combustion may reach at least about 100 K or at least about 200 K or at least about 300 K or at least about 400 K or at least about 500 K or even at least about 600 K or at least about 700 K or at least about 800 K or at least about 900 K or at least about 1000 K or at least about 1100 K or at least about 1200 K or at least about 1300 K or at least about 1400 K or at least about 1500 K or at least about 1600 K or at least about 1700 K or at least about 1800 K or at least about 1900 K or at least about 2000 K or at least about 2100 K or at least about 2200 K or at least about 2300 K or at least about 2400 K or at least about 2500 K. According to still other embodiments, the temperature during combustion may reach not greater than about 3000 K or not greater than about 2950 K or not greater than about 2900 K or not greater than about 2850 K or not greater than about 2800 K or not greater than about 2750 K or not greater than about 2700 K or not greater than about 2650 K or even not greater than about 2600 K. It will be appreciated that the temperature during combustion may be any value between, and including, any of the minimum and maximum values noted above. It will be further appreciated that the temperature during combustion may be within a range between, and including, any of the minimum and maximum values noted above. According to still other embodiments, the temperature during combustion may even exceed about 3,000K, for a brief time, e.g., about 0.1 to about 5 nanoseconds. After combustion, the temperature within the reaction chamber 10 may be around about 120° F. In some embodiments, a pressure within the reaction chamber 10 is maintained at about 5 to 20 psi prior to combustion. In some embodiments, a pressure within the reaction chamber 10 before combustion is about one half that of a pressure after combustion, for example to about 10 to 40 psi, to facilitate efficient conversion of the carbon-based flue gas or flare gas into graphene production.

In some embodiments, the system 100 may be automated to achieve a cost-efficient graphene production method on- or off-site. The automated system 100 determines the mixture for each internal combustion in the chamber to produce graphene in real time. In other embodiments, through the use of the user interface 34, the system 100 may be manually controlled.

In any embodiment, the system 100 may be configured to measure, in real-time, the make-up of the carbon-based gas or liquid. Such a measurement may be, for example, derived from the measured temperature and pressure changes within the reaction chamber 10 during and after combustion. The ratios of the carbon-based gas or liquid, hydrogen, and oxygen may be precisely adjusted to achieve a consistent graphene product, to modify the conversion of carbon from the carbon-based feedstock into graphene to increase the yield thereof, or ideally, both. After each combustion, the system 100 makes small adjustments as needed to one or more parameters to improve the efficiency of graphene production. A number of combustions may be required to reach optimal combustion conditions for a given carbon-based gas or liquid. However, the precise control of each of the input reactants allows the system 100 to operate with a wide range of carbon sources—even with a variable carbon source.

The ratios of carbon, hydrogen, and oxygen introduced into the reaction chamber 10 are carefully controlled in the system 100 in response to feedback provided by the sensors. In some embodiments, a ratio of carbon to hydrogen to oxygen in the reactants introduced into the reaction chamber 10 from the flue gas or flare gas source 50, the oxygen source 60, and the hydrogen source 70 is controlled to be approximately the same as that of graphene (i.e., about 140:42:20). This ratio may vary in view of byproducts produced during the combustion, such as water vapor.

In some embodiments, the system 100 does not include sulfur, i.e., no sulfur is introduced into the reaction chamber 10. In such embodiments, a reinforced graphene may be produced. In other embodiments, a sulfur-doped, electrically conductive graphene may be produced. In such embodiments, sulfur may be introduced into the reaction chamber through a separate injection port or may be present in or added to the carbon-based gas or liquid, the hydrogen, and/or the oxygen. In some embodiments, the carbon-based gas or liquid comprises sulfur in an amount of greater than 0 to about 5 wt %, about 0.1 to 4 wt %, about 0.25 to 3 wt %, about 0.5 to 2 wt %, or about 0.5 to 1 wt %. In some embodiments, the graphene may be formed in the reaction chamber 10 as a gel (including an aerogel, also known as aerographene), graphene layers such as sheets or films, or a combination thereof. In some embodiments, the gel is a preferred form. Post-processing of the aerogel or other graphene product may be used in connection with this disclosure to provide graphene in a desired form.

In one or more embodiments, variable layers of graphene may be generated in the reaction chamber 10 using a fluid dynamic manipulation process. The fluid dynamic manipulation process comprises, in combination with the above-described system 100, using electrical charges on substrate within the reaction chamber 10, such as a copper or a polymer substrate. This allows for increased control of graphene deposition, such as in layers (e.g., monolayer, few-layer, and nanoplatelets) and the thickness thereof formed in the process. In one or more embodiments, the graphene may be formed on the substrate as one or more layers of graphene sheets or nanoplatelets and, optionally, also formed as a graphene gel on the substrate, on the one or more layers, on other surfaces of the reaction chamber 10, or combinations thereof. Other conductive materials, particularly metals, may be used in place of copper, as well.

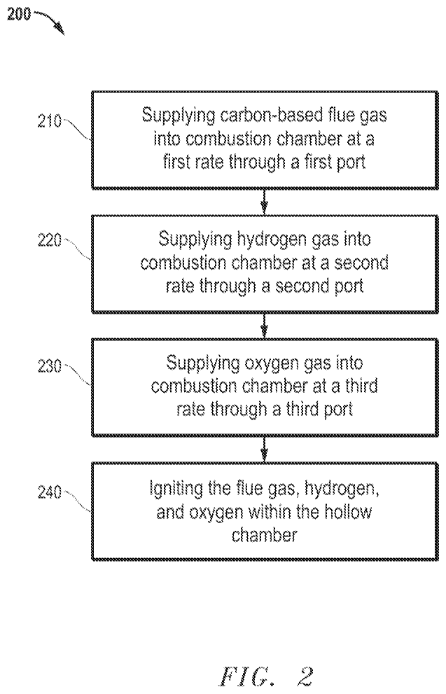

Turning to FIG. 2, described herein is a method 200 of producing graphene. The method 200 includes a step 210 of supplying a carbon-based flue gas or flare gas at a first rate into the reaction chamber 10 through injection port 58, a step 220 of supplying hydrogen at a second rate into the reaction chamber 10 through port 68, a step 230 of supplying oxygen at a third rate into the reaction chamber 10 through port 78; and a step 240 of igniting the flue gas or flare gas, hydrogen, and oxygen within the reaction chamber 10.

The carbon-based flue gas or flare gas supplied in step 210 may be the same as that described above. In some embodiments, step 210 may comprise directly or indirectly routing an exhaust gas from an industrial reaction process into the reaction chamber 10. In some embodiments, step 210 comprises pressurizing the flue gas or flare gas to, for example, about 50 psi or greater.

In some embodiments, step 220 may comprise electrolyzing water using a PEM electrolyzer to produce hydrogen gas and diverting the hydrogen gas to the reaction chamber 10. In some embodiments, step 220 comprises pressurizing the hydrogen to, for example, about 50 psi or greater.

In some embodiments, step 230 may comprise electrolyzing water using a PEM electrolyzer to produce oxygen gas and diverting the oxygen gas to the reaction chamber 10. In some embodiments, step 230 comprises pressurizing the oxygen to, for example, about 50 psi or greater.

In one or more embodiments, the method 200 includes a further step of measuring at least one parameter within the reaction chamber 10 after step 230, wherein the parameter is a temperature, a pressure, and/or an opacity. In such embodiments, the method 200 may further include then repeating steps 210, 220, 230, and 240, wherein at least one of steps 210, 220, or 230 is modified in view of the measure parameter. In some embodiments, the method 200 is automated using the controller 30 described above. In such embodiments, the above iterative process may be repeatedly performed until optimal combustion conditions are achieved within the reaction chamber 10.

The term “about,” as used herein, refers to both numbers in a range when used before the lower end of each such range. It is intended to encompass a variation in each such range to cover amounts that still work for the stated or recited purpose unless otherwise specified.

The system and method disclosed herein are able to maintain a consistent product by gathering live data from sensors and adjusting ratios of hydrogen and oxygen mixed and combusted in response to live data from the sensors. The system times the combustion event for a repeatable process capable of generating bulk graphene and other carbon allotrope materials. The system is also capable for use as an applicator process to coat substrates with graphene. The system further provides the ability to upcycle industry waste, including by-products such as greenhouse gasses into new materials that can be used in industry to create a sustainable future.

An advantage of using independent hydrogen and oxygen sources in the present system is that it allows the reaction chamber to process a variety of variable carbon-based gases and liquids and reduce carbon emission. The system creates a product that has a multitude of applications across several industries. The system is also capable of being portable to scalable, allowing for remote applications needing large scale capture.

Many different aspects and embodiments are possible. Some of those aspects and embodiments are described herein. After reading this specification, skilled artisans will appreciate that those aspects and embodiments are only illustrative and do not limit the scope of the present invention. Embodiments may be in accordance with any one or more of the embodiments as listed below.

Embodiment 1. A system for graphene synthesis, comprising: an enclosed chamber comprising a hollow interior; a carbon-based gas source fluidically coupled to the chamber and configured to supply a carbon-based gas to the hollow interior; a hydrogen source that is independent of the carbon-based gas source and that is fluidically coupled to the chamber and configured to supply hydrogen to the hollow interior; an oxygen source that is independent of the carbon-based gas source and that is fluidically coupled to the chamber and configured to supply oxygen to the hollow interior; an igniter configured to ignite the carbon-based gas, hydrogen, and oxygen in the hollow interior; a first flow meter coupled to the carbon-based gas source, a second flow meter coupled to the hydrogen source, a third flow meter coupled to the oxygen source; and a controller in communication with and configured to receive flow data from the first, second, and third flow meters; wherein the controller is configured to adjust flow from one or more of the carbon-based gas source, the hydrogen source, and/or the oxygen source in response to the flow data.

Embodiment 2. The system of embodiment 1, wherein the carbon-based gas is a flue gas or flare gas resulting from an industrial reaction process.

Embodiment 3. The system of embodiment 2, wherein the industrial reaction process is a coal energy plant, a drilling operation, a combustion engine, or a landfill.

Embodiment 4. The system of embodiment 2, wherein the carbon-based gas source comprises a storage tank, an inlet line, and an outlet line; wherein the storage tank is coupled to the chamber via the outlet line; and wherein the flue gas or flare gas is directed from the industrial reaction process through the inlet line to the storage tank.

Embodiment 5. The system of embodiment 2, wherein the chamber is co-located with the industrial reaction process.

Embodiment 6. The system of embodiment 1, further comprising an inert gas source fluidically coupled to the chamber and configured to supply an inert gas to the hollow interior.

Embodiment 7. The system of embodiment 1, wherein the carbon-based gas source is coupled to the chamber via a first one-way valve, the hydrogen source is coupled to the chamber via a second one-way valve, and the oxygen source is coupled to the chamber via a third one-way valve.

Embodiment 8. The system of embodiment 7, wherein the chamber further comprises an exhaust valve.

Embodiment 9. The system of embodiment 1, further comprising a pressure sensor configured to measure a pressure within the hollow interior and a temperature sensor configured to measure a temperature within the hollow interior; wherein the controller is in communication with and configured to receive pressure data from the pressure sensor; wherein the controller is in communication with and configured to receive temperature data from the temperature sensor; and wherein the controller is configured to adjust flow from one or more of the carbon-based gas source, the hydrogen source, and the oxygen source in response to the flow data, the pressure data, the temperature data, or a combination thereof.

Embodiment 10. The system of embodiment 1, wherein the carbon-based gas is carbon dioxide, methane, propane, acetylene, butane, or combinations thereof.

Embodiment 11. A method of producing graphene, comprising: supplying a carbon-containing flue gas or flare gas at a first rate into a hollow chamber through a first port; supplying hydrogen at a second rate into the hollow chamber through a second port; supplying oxygen at a third rate into the hollow chamber through a third port; and igniting the flue gas or flare gas, hydrogen, and oxygen within the hollow chamber.

Embodiment 12. The method of embodiment 11, further comprising: after igniting, measuring a pressure and a temperature in the hollow chamber; and separately adjusting the first rate, the second rate, the third rate, or a combination thereof in response to the measured pressure and temperature.

Embodiment 13. The method of embodiment 12, further comprising: after separately adjusting, igniting the flue gas or flare gas, hydrogen, and oxygen within the hollow chamber; measuring the pressure and the temperature in the hollow chamber; and separately adjusting the first rate, the second rate, the third rate, or a combination thereof in response to the measured pressure and temperature.

Embodiment 14. The method of embodiment 11, wherein supplying the hydrogen comprises producing hydrogen from water using a proton exchange membrane; or wherein supplying the oxygen comprises producing oxygen from water using a proton exchange membrane.

Embodiment 15. The method of embodiment 11, wherein a ratio between the second rate and the third rate is from about 0.1:1 to 1.9:1 or about 2.1:1 to 10:1.

Embodiment 16. The method of embodiment 11, wherein the flue gas or flare gas comprises carbon dioxide, methane, propane, acetylene, butane, or combinations thereof.

Embodiment 17. The method of embodiment 11, wherein the flue gas or flare gas comprises greater than 0 to about 5 wt % of sulfur.

Embodiment 18. The method of embodiment 11, wherein the flue gas is from an industrial reaction process.

Embodiment 19. A graphene composition comprising: a sulfur-doped graphene formed by: separately introducing a carbon-containing flue gas or flare gas, hydrogen, and oxygen at into a reaction chamber; and igniting the flue gas or flare gas, hydrogen, and oxygen within the reaction chamber; wherein flue gas or flare gas comprises sulfur.

Embodiment 20. The graphene composition of embodiment 19, wherein the flue gas or flare gas comprises about 0.5 to 1 wt % sulfur.

Although various embodiments have been shown and described, the disclosure is not limited to such embodiments and will be understood to include all modifications and variations as would be apparent to one of ordinary skill in the art. Therefore, it should be understood that the disclosure is not intended to be limited to the particular forms disclosed; rather, the intention is to cover all modifications, equivalents, and alternatives falling within the spirit and scope of the disclosure as defined by the appended claims.

What is claimed is:

1. A system for graphene synthesis, comprising:
an enclosed chamber comprising a hollow interior;
a carbon-based gas source fluidically coupled to the chamber and configured to supply a carbon-based gas to the hollow interior;
a hydrogen source that is independent of the carbon-based gas source and that is fluidically coupled to the chamber and configured to supply hydrogen to the hollow interior;
an oxygen source that is independent of the carbon-based gas source and that is fluidically coupled to the chamber and configured to supply oxygen to the hollow interior;
an igniter configured to ignite the carbon-based gas, hydrogen, and oxygen in the hollow interior;
a first flow meter coupled to the carbon-based gas source, a second flow meter coupled to the hydrogen source, a third flow meter coupled to the oxygen source; and
a controller in communication with and configured to receive flow data from the first, second, and third flow meters;
wherein the controller is configured to adjust flow from one or more of the carbon-based gas source, the hydrogen source, and/or the oxygen source in response to the flow data.

2. The system of claim 1, wherein the carbon-based gas is a flue gas or flare gas resulting from an industrial reaction process.

3. The system of claim 2, wherein the industrial reaction process is a coal energy plant, a drilling operation, a combustion engine, or a landfill.

4. The system of claim 2, wherein the carbon-based gas source comprises a storage tank, an inlet line, and an outlet line;
wherein the storage tank is coupled to the chamber via the outlet line; and
wherein the flue gas or flare gas is directed from the industrial reaction process through the inlet line to the storage tank.

5. The system of claim 2, wherein the chamber is co-located with the industrial reaction process.

6. The system of claim 1, further comprising an inert gas source fluidically coupled to the chamber and configured to supply an inert gas to the hollow interior.

7. The system of claim 1, wherein the carbon-based gas source is coupled to the chamber via a first one-way valve, the hydrogen source is coupled to the chamber via a second one-way valve, and the oxygen source is coupled to the chamber via a third one-way valve.

8. The system of claim 7, wherein the chamber further comprises an exhaust valve.

9. The system of claim 1, further comprising a pressure sensor configured to measure a pressure within the hollow interior and a temperature sensor configured to measure a temperature within the hollow interior;
wherein the controller is in communication with and configured to receive pressure data from the pressure sensor;
wherein the controller is in communication with and configured to receive temperature data from the temperature sensor; and
wherein the controller is configured to adjust flow from one or more of the carbon-based gas source, the hydrogen source, and the oxygen source in response to the flow data, the pressure data, the temperature data, or a combination thereof.

10. The system of claim 1, wherein the carbon-based gas is carbon dioxide, methane, propane, acetylene, butane, or combinations thereof.

11. A method of producing graphene, comprising:
supplying a carbon-containing flue gas or flare gas at a first rate into a hollow chamber through a first port;
supplying hydrogen at a second rate into the hollow chamber through a second port;
supplying oxygen at a third rate into the hollow chamber through a third port; and
igniting the flue gas or flare gas, hydrogen, and oxygen within the hollow chamber.

12. The method of claim 11, further comprising:
after igniting, measuring a pressure and a temperature in the hollow chamber; and
separately adjusting the first rate, the second rate, the third rate, or a combination thereof in response to the measured pressure and temperature.

13. The method of claim 12, further comprising:
after separately adjusting, igniting the flue gas or flare gas, hydrogen, and oxygen within the hollow chamber;
measuring the pressure and the temperature in the hollow chamber; and
separately adjusting the first rate, the second rate, the third rate, or a combination thereof in response to the measured pressure and temperature.

14. The method of claim 11, wherein supplying the hydrogen comprises producing hydrogen
from water using a proton exchange membrane; or
wherein supplying the oxygen comprises producing oxygen from water using a proton exchange membrane.

15. The method of claim 11, wherein a ratio between the second rate and the third rate is from about 0.1:1 to 1.9:1 or about 2.1:1 to 10:1.

16. The method of claim 11, wherein the flue gas or flare gas comprises carbon dioxide, methane, propane, acetylene, butane, or combinations thereof.

17. The method of claim 11, wherein the flue gas or flare gas comprises greater than 0 to about 5 wt % of sulfur.

18. The method of claim 11, wherein the flue gas is from an industrial reaction process.

19. A graphene composition comprising:
a sulfur-doped graphene formed by:
separately introducing a carbon-containing flue gas or flare gas, hydrogen, and oxygen at into a reaction chamber; and
igniting the flue gas or flare gas, hydrogen, and oxygen within the reaction chamber;
wherein flue gas or flare gas comprises sulfur.

20. The graphene composition of claim 19, wherein the flue gas or flare gas comprises about 0.5 to 1 wt % sulfur.
